(19) United States
(12) Patent Application Publication
(10) Pub. No.: US 2007/0233496 A1
(43) Pub. Date: Oct. 4, 2007

(54) Multi-function digitizer

(75) Inventor: Tzong-Wei Uen, Miao-Li City (TW)

Correspondence Address: LEONG C LEI, PMB # 1008, 1867 YGNACIO VALLEY ROAD, WALNUT CREEK, CA, 94598, US

(73) Assignee: UC-Logic Technology Corp.

(21) Appl. No.: 11/392,758

(22) Filed: Mar. 30, 2006

(51) Int. Cl. G10L 21/00

(52) U.S. Cl. 704/270

(57) ABSTRACT

A multi-function digitizer is provided, which contains a speaker unit and a microphone unit, in addition to the digitizing board and stylus. A user's handwriting traces and voice are collected by the digitizing board and the microphone unit respectively, delivered by the digitizer to a computer, and then processed and forwarded by the computer to the other party over a network to which the computer is connected. On the other hand, the voice of the other party is transmitted over the network to the computer, processed and forwarded by the computer to the digitizer, and then presented through the speaker unit.

### BACKGROUND OF THE INVENTION

(a) Technical Field of the Invention

The present invention generally relates to digitizers, and more particularly to a digitizer supplemented with audio and visual functions.

(b) Description of the Prior Art

Digitizer as an input device to the computer has a history probably as long as that of the mouse. In the early days of computer, digitizers are mainly used for CAD/CAM drawings. Then, with the later advancement of the handwriting recognition and graphing software, the digitizers have found widespread applications among general users and computer artists.

On the other hand, with the ubiquitous Internet, two-way IP-based voice communication is gaining popularity as significant breakthroughs has been achieved in terms of bandwidth utilization and voice clarity. The speaker and microphone are therefore become vital input and output devices to a computer.

Conventionally, as shown in FIG. 1, the speaker (A3) or headset (A4), the microphone (A41), and the digitizer (A1) having a stylus (A2) are all cabled separately to the computer (A5). With the advancement of the IP-based voice communications, there are new headset devices combining earphone and microphone together that can be easily and comfortably worn on a user's head for conducting voice communications.

To further enhance communications, it has been proposed and implemented that the handwriting traces written on a digitizer are transmitted over Internet and displayed on the screen of another computer. However, there is not yet a product that integrates the speaker, the microphone, and the digitizer into a single device.

### SUMMARY OF THE INVENTION

The primary purpose of the present invention is to provide a multi-function digitizer that integrates the microphone and the speaker into a single device. With such a multi-function device, a user can conduct two-way voice communications with another party over the Internet comfortably without wearing any headset, and, if required, graphic and text information can be presented to the other party's computer screen by writing on the digitizer during the conversation.

The multi-function digitizer is connected to a computer via appropriate cabling, and the computer is in turn linked to a network. The digitizer contains a speaker unit and a microphone unit, in addition to the digitizing board and stylus. A user's handwriting traces and voice are collected by the digitizing board and the microphone unit respectively, delivered by the digitizer to the computer, and then processed and forwarded by the computer to the other party over the network. On the other hand, the voice of the other party is transmitted over the network to the computer, processed and forwarded by the computer to the digitizer, and then presented through the speaker unit. The speaker unit and the microphone unit can be built in or externally connected to the digitizer.

The multi-function digitizer can further contain a camera unit through which images can be collected and transmitted to the other party, turning the two-way voice conversation into a video conference. The camera unit can be built in or externally connected to the digitizer via a built-in USB hub of the digitizer.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional computing environment.

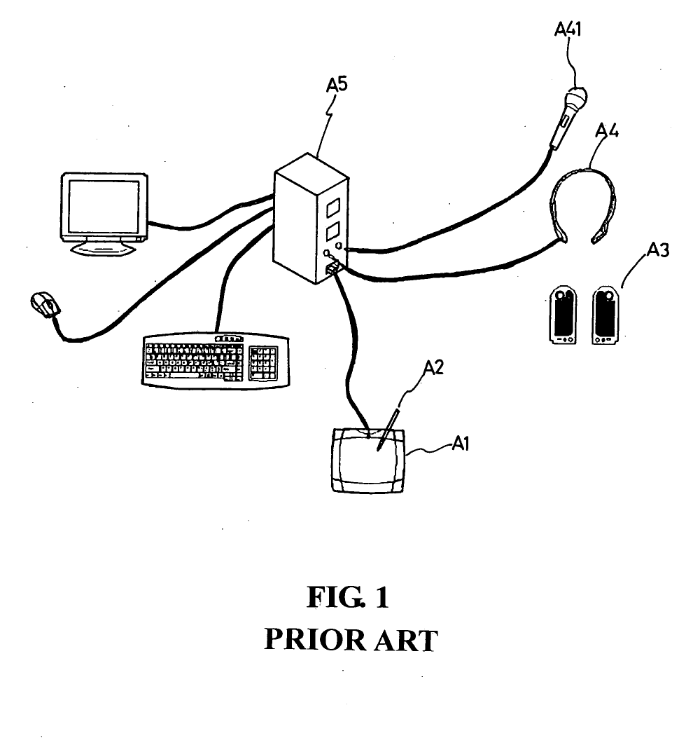

FIG. 2 is a schematic diagram showing the multi-function digitizer according to a first embodiment of the present invention.

FIG. 3 is a schematic diagram showing the multi-function digitizer according to a second embodiment of the present invention.

FIG. 4 is a schematic diagram showing the multi-function digitizer according to a third embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

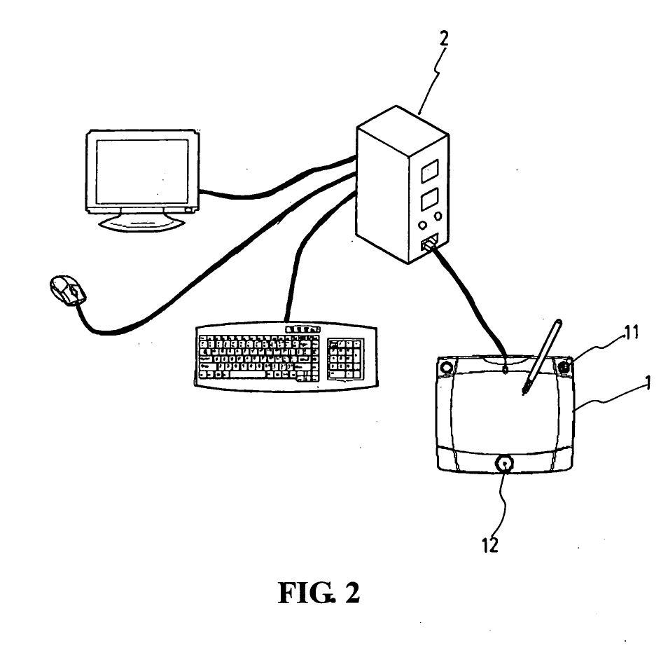

FIG. 2 is a schematic diagram showing the multi-function digitizer according to a first embodiment of the present invention. As illustrated, the digitizer 1 has, in addition to the digitizing board and stylus (both not numbered), at least a built-in speaker unit 11 (there can be more speaker units functioning as main speaker and auxiliary speakers) and a built-in microphone unit 12, through which two-way IP-based voice communication can be conducted via the digitizer 1. The user's handwriting traces and voice are collected by the digitizing board and the microphone unit 12 respectively, delivered by the digitizer 1 to the computer 2, and then processed and forwarded by the computer 2 to the other party over a network (e.g., the Internet) to which the computer 2 is connected. On the other hand, the voice of the other party is transmitted over the network to the computer 2, processed and forwarded by the computer 2 to the digitizer 1, and then presented through the speaker unit 11.

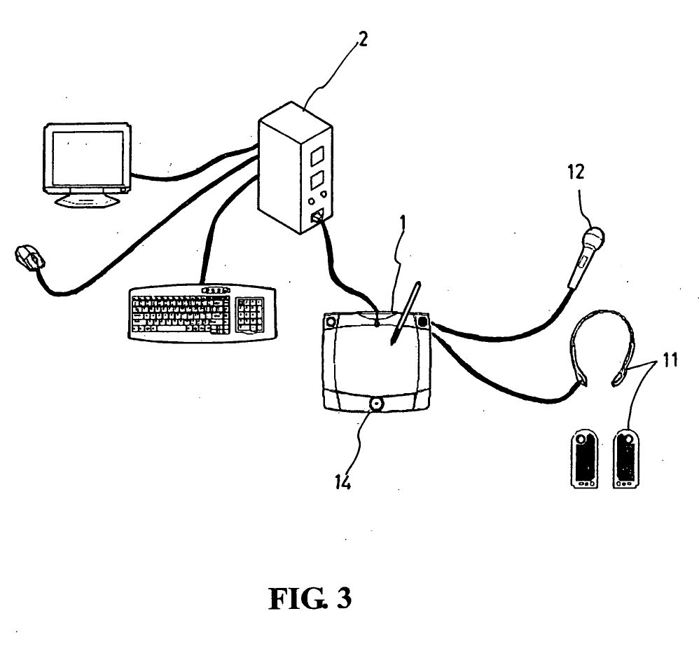

FIG. 3 is a schematic diagram showing the multi-function digitizer according to a second embodiment of the present invention. In the present embodiment, the speaker unit (or headset) 11 and the microphone unit 12 are externally connected to the appropriate ports of the digitizer 1 having a built-in camera unit 14. The digitizer 1 is connected to the computer 2 via appropriate cabling as in the previous embodiment. The traces, voice and images collected by the digitizing board, the microphone unit 12, and the camera unit 14 respectively are delivered by the digitizer 1 to the computer 2, and then processed and forwarded by the computer 2 to the other party over a network. The voice of the other party is transmitted over the network to the computer 2, processed and forwarded by the computer 2 to the digitizer 1, and then presented through the speaker unit 11.

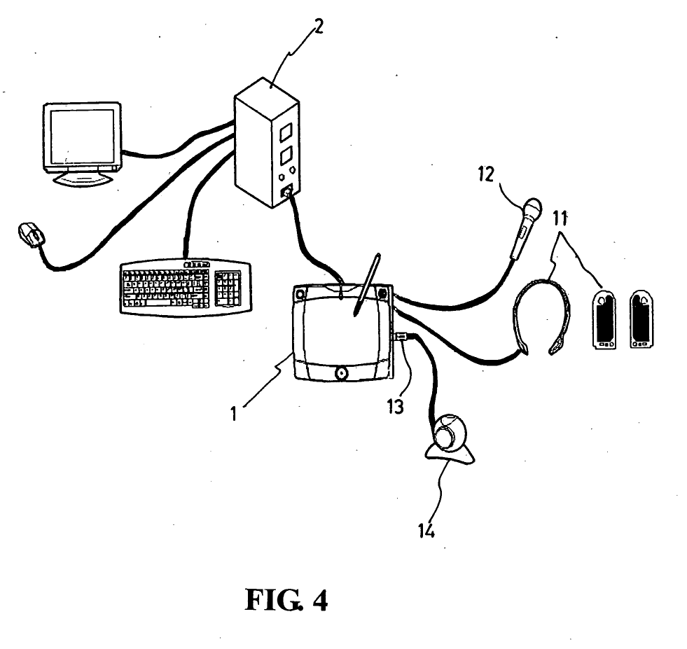

FIG. 4 is a schematic diagram showing the multi-function digitizer according to a third embodiment of the present invention. In the present embodiment, the speaker unit (or headset) 11 and the microphone unit 12 are externally connected to the appropriate ports of the digitizer 1. The digitizer 1 also has a built-in USB hub 13 for connecting a number of USB-based devices such as a USB camera unit 14. The digitizer 1 is connected to the computer 2 via appropriate cabling as in the previous embodiments. The traces, voice, and images collected by the digitizing board, the microphone unit 12, and the camera unit 14 respectively are delivered by the digitizer 1 to the computer 2, and then processed and forwarded by the computer 2 to the other party over a network. The voice of the other party is transmitted over the network to the computer 2, processed and forwarded by the computer 2 to the digitizer 1, and then presented through the speaker unit 11. In an alternative embodiment, the speaker unit 11 and the microphone unit 12 can also be built-in ones.

Please note that the speaker unit 11, the microphone unit 12, the camera unit 14, and the digitizing board function independently. When not conducting two-way IP-based voice communications, for example, the speaker unit 11 is just like an ordinary speaker of the computer 2 through which the sound and music played by the computer 2 are presented. Similarly, when not conducting two-way communications, the digitizing board functions just like an ordinary digitizer of the computer 2.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-function digitizer externally connected to a computer via appropriate cabling, said computer being connected to a network, said digitizer comprising:
a digitizing board and a stylus for writing on said digitizer board;
a microphone unit for collecting voice; and
a speaker unit for presenting voice;
wherein the traces and voice collected by said digitizing board and said microphone unit respectively are delivered by said digitizer to said computer, and then processed and forwarded by said computer to another party over said network; and the voice of said another party is transmitted over said network to said computer, processed and forwarded by said computer to the digitizer, and then presented through said speaker unit.

2. The multi-function digitizer according to claim 1, wherein said speaker unit and said microphone unit are externally connected to said digitizer via appropriate ports of said digitizer.

3. The multi-function digitizer according to claim 1, further comprising a USB hub for connecting at least an external USB-based device.

4. The multi-function digitizer according to claim 1, further comprising a camera unit wherein the images collected by said camera unit are delivered by said digitizer to said computer, and then processed and forwarded by said computer to another party over said network.
